(19) United States
(12) Patent Application Publication
(10) Pub. No.: US 2019/0273871 A1
(43) Pub. Date: Sep. 5, 2019

(54) PEDESTRIAN TRACKING USING DEPTH SENSOR NETWORK

(71) Applicant: OTIS Elevator Company, Farmington, CT (US)

(72) Inventors: Yanzhi Chen, Shanghai (CN); Hui Fang, Shanghai (CN); Zhen Jia, Shanghai (CN); Alan Matthew Finn, Hebron, CT (US); Arthur Hsu, South Glastonbury, CT (US)

(21) Appl. No.: 16/279,412

(22) Filed: Feb. 19, 2019

(30) Foreign Application Priority Data
Mar. 5, 2018 (CN) 201810211942.2

(51) Int. Cl. H04N 5/232; H04N 5/04; H04N 7/18

(52) U.S. Cl. CPC H04N 5/23299; H04N 7/181; H04N 5/04

(57) ABSTRACT

An object tracking system is provided and includes a depth sensor deployed to have at least a nearly continuous field of view (FOV) and a controller coupled to the depth sensor. The controller is configured to spatially and temporally synchronize output from the depth sensor and to track respective movements of each individual object within the nearly continuous FOV as each individual object moves through the nearly continuous FOV.

### CROSS REFERENCE TO RELATED APPLICATION

This patent application claims priority to Chinese Patent Application Ser. No. 201810211942.2, filed Mar. 5, 2018, which is incorporated herein by reference in its entirety.

### BACKGROUND

The following description relates to pedestrian tracking and, more specifically, to a method of pedestrian tracking using a network of partially or completely overlapped depth sensors.

Pedestrian tracking plays an important role in intelligent building technologies. These include, but are not limited to, building security and safety technologies, elevator scheduling optimization technologies and building energy control technologies.

The performance of pedestrian tracking methods is usually affected by two related issues: a crowd of pedestrians typically results in the occlusion of targeted individuals and most sensors have a limited field of view (FOV). As such, systems may have difficulty accurately tracking multiple moving pedestrians across a wide area such as, for example, a large elevator lobby area.

### BRIEF DESCRIPTION

According to an aspect of the disclosure, an object tracking system is provided and includes a depth sensor deployed to have at least a nearly continuous field of view (FOV) and a controller coupled to the depth sensor. The controller is configured to spatially and temporally synchronize output from the depth sensor and to track respective movements of each individual object within the nearly continuous FOV as each individual object moves through the nearly continuous FOV.

In accordance with additional or alternative embodiments, the depth sensor is deployed to have a continuous FOV.

In accordance with additional or alternative embodiments, the spatial synchronization is obtained from a comparison between output from the depth sensor and a coordinate system defined for the object tracking region and the depth sensor.

In accordance with additional or alternative embodiments, the temporal synchronization is obtained by one or more of reference to a network time and time stamps of the output of the depth sensor.

According to another aspect of the disclosure, an object tracking system is provided and includes a structure formed to define an object tracking region, a network of depth sensors deployed throughout the structure to have at least a nearly continuous field of view (FOV) which is overlapped with at least a portion of the object tracking region and a controller coupled to the depth sensors. The controller is configured to spatially and temporally synchronize output from each of the depth sensors and to track respective movements of each individual object within the nearly continuous FOV as each individual object moves through the nearly continuous FOV.

In accordance with additional or alternative embodiments, the object tracking region includes an elevator lobby.

In accordance with additional or alternative embodiments, the object tracking region includes a pedestrian walkway in a residential, industrial, military, commercial or municipal property.

In accordance with additional or alternative embodiments, the network of depth sensors is deployed throughout the structure to have a continuous overlapped FOV.

In accordance with additional or alternative embodiments, the spatial synchronization is obtained from a comparison between output from each of the depth sensors and a coordinate system defined for the object tracking region and each of the depth sensors.

In accordance with additional or alternative embodiments, the temporal synchronization is obtained by reference to a network time.

In accordance with additional or alternative embodiments, the temporal synchronization is obtained from time stamps of the output of each of the depth sensors.

According to yet another aspect of the disclosure, an object tracking method is provided and includes deploying depth sensors to have at least a nearly continuous field of view (FOV), spatially and temporally synchronizing the depth sensors to world coordinates and a reference time, collecting depth points from each depth sensor, converting the depth points to depth points of the world coordinates, projecting the depth points of the world coordinates onto a plane; and executing data association with respect to the projection of the depth points of the world coordinates onto sequential maps of the plane during passage of the reference time to remove outlier tracklets formed by projected depth points in a relatively small number of the maps and to group remaining tracklets formed by projected depth points in a relatively large number of the maps.

In accordance with additional or alternative embodiments, the deploying includes deploying the depth sensors in a network within a structure formed to define an object tracking region such that the nearly continuous FOV overlaps with at least a portion of the object tracking region.

In accordance with additional or alternative embodiments, the deploying includes deploying the depth sensors to have a continuous FOV.

In accordance with additional or alternative embodiments, the spatially synchronizing of the depth sensors to the world coordinates includes calibrating each of the depth sensors to the world coordinates and the temporally synchronizing of the depth sensors to the reference time includes one or more of linking to a network time and time stamping output of each of the depth sensors.

In accordance with additional or alternative embodiments, the relatively small and large numbers of the maps are updateable.

In accordance with additional or alternative embodiments, the method further includes executing a nearest neighbor search to group the remaining tracklets.

In accordance with additional or alternative embodiments, the converting of the depth points to the depth points of the world coordinates includes converting each of the depth points to the depth points of the world coordinates.

In accordance with additional or alternative embodiments, the method further includes executing a shape model to aggregate multiple points with a spatial distribution for subsequent projection or to aggregate multiple projected points into a point for subsequent tracking.

These and other advantages and features will become more apparent from the following description taken in conjunction with the drawings.

### BRIEF DESCRIPTION OF THE DRAWINGS

The subject matter, which is regarded as the disclosure, is particularly pointed out and distinctly claimed in the claims at the conclusion of the specification. The foregoing and other features and advantages of the disclosure are apparent from the following detailed description taken in conjunction with the accompanying drawings in which:

FIG. 1 is an illustration of a sequence of an image, a depth map and object segmentation generated during pedestrian detection operations based on depth information;

FIG. 2 is a schematic top-down view of a system including a network of depth sensors deployed in a structure in accordance with embodiments; and

FIG. 3 is a schematic diagram of a controller of the system of FIG. 2 in accordance with embodiments;

FIG. 4 is a schematic diagram of a controller(s) network time protocol (NTP) server relationship in accordance with embodiments;

FIG. 5 is a flow diagram illustrating a method of pedestrian tracking in accordance with embodiments;

FIG. 6 is a flow diagram illustrating a method of pedestrian tracking in accordance with embodiments;

FIG. 7A is a graphical depiction of depth sensor output with a top-down view in accordance with embodiments;

FIG. 7B is a graphical depiction of individually tracked objects taken from depth sensor output in accordance with embodiments;

FIG. 7C is a graphical depiction of individually tracked objects taken from depth sensor output with outlier tracklets removed in accordance with embodiments;

FIG. 7D is a graphical depiction of individually tracked objects taken from depth sensor output with remaining tracklets grouped in accordance with embodiments;

FIG. 8A is a graphical depiction of a shape model in accordance with embodiments; and

FIG. 8B is a graphical depiction of a shape model in accordance with embodiments.

These and other advantages and features will become more apparent from the following description taken in conjunction with the drawings.

### DETAILED DESCRIPTION

As will be described below, a pedestrian tracking system is provided to accurately track multiple moving pedestrians across a wide area. The pedestrian tracking system includes multiple sensors (e.g., 2D, 3D or depth sensors) with a near-continuous field of view (FOV) or, in one embodiment, multiple, spatially overlapped sensors with a continuous FOV. In either case, each of the multiple sensors have the capability to distinguish between multiple moving objects even when a number of those moving objects are occluded.

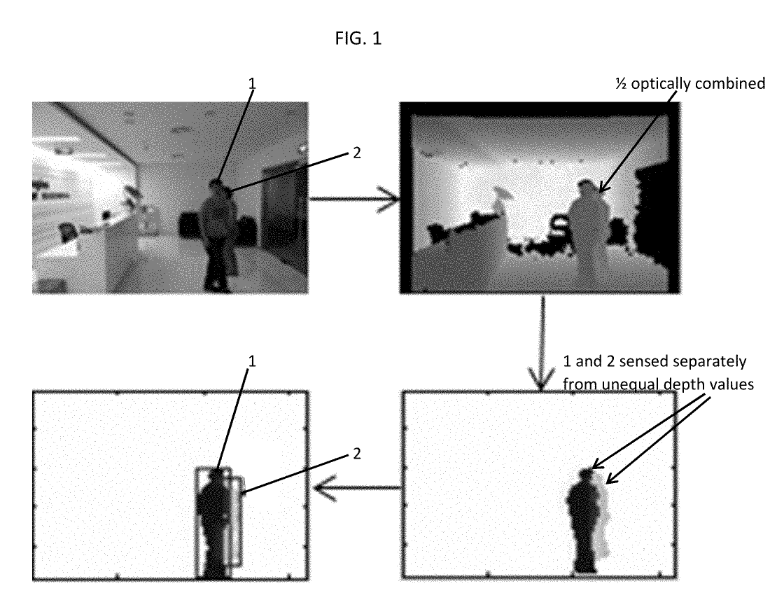

With reference to FIG. 1, in contrast to 2D red, green, blue (RGB) surveillance cameras, a depth sensor provides three-dimensional (3D) information that includes the distance between the object and the depth sensor. Various 3D depth sensing technologies and devices that can be used include, but are not limited to, a structured light measurement, phase shift measurement, time of flight measurement, stereo triangulation device, sheet of light triangulation device, light field cameras, coded aperture cameras, computational imaging techniques, simultaneous localization and mapping (SLAM), imaging radar, imaging sonar, echolocation, laser radar, scanning light detection and ranging (LIDAR), flash LIDAR or a combination including at least one of the foregoing. Different technologies can include active (transmitting and receiving a signal) or passive (only receiving a signal) and may operate in a band of the electromagnetic or acoustic spectrum such as visual, infrared, ultrasonic, etc. In various embodiments, a 3D depth sensor may be operable to produce 3D information from defocus, a focal stack of images or structure from motion. Similarly, 2D depth sensors provide two-dimensional information that includes the distance between the object and the depth sensor.

There are both qualitative and quantitative differences between conventional 2D visible-spectrum imaging and depth sensing. In 2D imaging (equivalently 2D video, since 2D video includes successive 2D images), the reflected color (mixture of wavelengths) from the first object in each radial direction from the camera is captured. The image, then, is a 2D projection of the 3D world where each pixel is the combined spectrum of the source illumination and the spectral reflectivity of an object in the scene (and, possibly, the object's own emissivity). In depth sensing, there is no color (spectral) information. Rather, each ‘pixel’ is the distance (depth, range) to the first object in each radial direction from the depth sensor. The data from depth sensing is typically called a depth map or point cloud.

Sometimes, a depth map or point cloud is confusingly called a depth image or 3D image, but it is not an image in any conventional sense of the word. Generally, a 2D image cannot be converted into a depth map and a depth map cannot be converted into a 2D image (an artificial assignment of contiguous colors or grayscale to contiguous depths allows a person to crudely interpret a depth map somewhat akin to how a person sees a 2D image as in FIG. 1.

As shown in FIG. 1, the locations of two pedestrians 1 and 2 overlap such that a two-dimensional (2D) object detection algorithm cannot separate them (as shown in the first image in the sequence). However, since their depth values are unequal (see, e.g., the second depth map in the sequence), it follows that the use of depth information provides depth sensors with the ability to separate the objects and thereby detect the separated objects, such as the pedestrians 1 and 2, with relatively high accuracy and occlusion tolerance (as shown in the third and fourth segmentation processing results in the sequence).

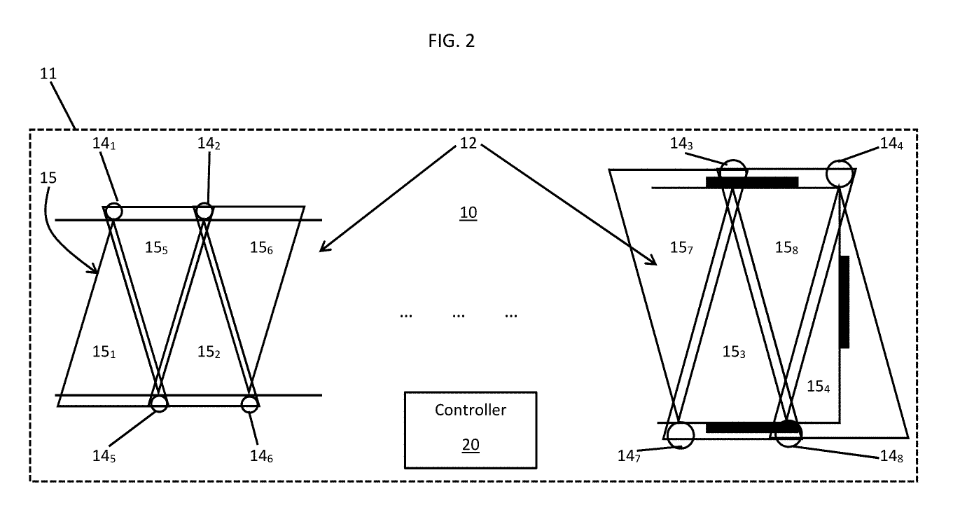

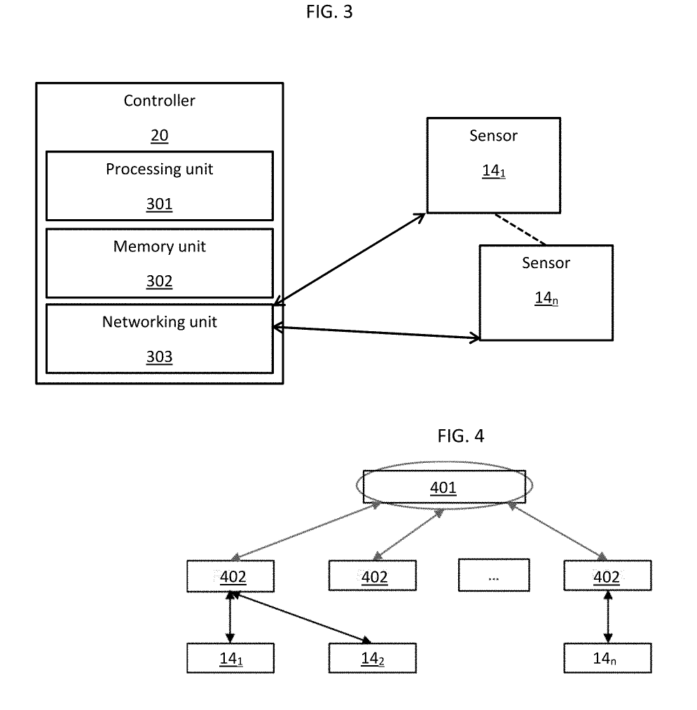

With reference to FIG. 2, an object tracking system 10 is provided. The object tracking system 10 may include or be deployed in a structure 11 that is formed to define an object tracking region 12. The object tracking region 12 may be provided as an elevator lobby or a pedestrian walkway of or in a residential, industrial, military, commercial or municipal property or any other defined region or space. The object tracking system 10 may further include a network of 3D depth sensors 14₁₋ₙ and a controller 20. The network of 3D depth sensors 14₁₋ₙ, is deployed throughout the structure 11 to have at least a nearly continuous combined field of view (FOV) 15 which is made up of the respective FOVs 15₁₋ₙ of each of the 3D depth sensors 14₁₋ₙ and which is overlapped with at least a portion of the object tracking region 12. The controller 20 is coupled to or otherwise disposed in signal communication with each of the 3D depth sensors 14₁₋ₙ (see FIG. 3).

As used herein, a nearly continuous combined FOV 15 may be characterized in that the respective FOVs 15₁₋ₙ of each of the 3D depth sensors 14₁₋ₙ overlap with significant portions of neighboring FOVs 15₁₋ₙ or, to the extent that such overlapping is not provided or possible, as in the case of a corner or a hidden area within the object tracking region 12, spaces between neighboring FOVs 15₁₋ₙ are configured to be relatively small as compared to the overall sizes of the FOVs 15₁₋ₙ.

While the description provided herein refers to 3D depth sensors, it is to be understood that embodiments exist in which the sensors are a mix of 2D and/or 3D depth sensors as well. In the case of 2D depth sensors, in particular, such sensors would provide depth information relating to distances between objects and the 2D depth sensors but may not provide additional detail relating to a shape and size of the objects. Reference to 3D depth sensors herein is, therefore, done for clarity and brevity and should not be interpreted in such a way as to otherwise limit the scope of the claims or the application as a whole.

In accordance with embodiments, each of the 3D depth sensors 14₁₋ₙ may include or be provided as a depth sensor or, more particularly, as a Kinect™ or Astra™ sensor.

With reference to FIG. 3, the controller 20 may include a processing unit 301, a memory unit 302 and a networking unit 303 disposed in signal communication with at least the 3D depth sensors 14₁₋ₙ. The memory unit 302 has executable instructions stored thereon which are readable and executable by the processing unit 301. When the executable instructions are read and executed by the processing unit 301, the executable instructions cause the processing unit to spatially and temporally synchronize output from each of the 3D depth sensors 14₁₋ₙ, to sense, track, observe or identify individual objects within the nearly continuous combined FOV 15 and to track respective movements of each of the individual objects as each of the individual objects moves through the nearly continuous combined FOV 15.

It should be noted at this point, that tracking could have difficulty with segmenting each of the individual objects. As such, a tracking algorithm may include or have track fork and join capabilities. As used herein, fork and join capabilities refer to the separation of one track into more than one track and the merging of one or more tracks into one track.

In accordance with embodiments, the spatial synchronization may be obtained by the processing unit 301 from a comparison between output from each of the 3D depth sensors 14₁₋ₙ with a coordinate system that is defined for the object tracking region 12 and for each of the 3D depth sensors 14₁₋ₙ. The temporal synchronization may be obtained by the processing unit 301 by one or more of reference to a network time and from time stamps of the output of each of the 3D depth sensors 14₁₋ₙ.

In accordance with embodiments, the coordinate system may be provided as a Cartesian coordinate system. However, it is to be understood that this is not required and that any other coordinate system can be used as long as it can be established consistently throughout the object tracking region 12.

With reference to FIG. 4, the network time may be maintained by a network time protocol (NTP) server 401 which is disposed in signal communication with the controller 20, which may be a singular feature/server or a feature/server which is effectively distributed across multiple individual controllers 402 for one or more of the 3D depth sensors 14₁₋ₙ. In the latter case, the multiple individual controllers 402 may be linked via a network, such as the Internet, a local network or any other known network, and the 3D depth sensors 14₁₋ₙ may be linked via USB connections or any other known connection.

In accordance with embodiments, the temporal synchronization and/or the reference time may also take into account an interval of time between collection of three-coordinate depth points from each of the 3D depth sensors 14₁₋ₙ.

Although the network of 3D depth sensors 14₁₋ₙ is described above as being deployed throughout the structure 11 to have at least the nearly continuous combined field of view (FOV) 15 which is made up of the respective FOVs 15₁₋ₙ of each of the 3D depth sensors 14₁₋ₙ, it is to be understood that the network of 3D depth sensors 14₁₋ₙ may be deployed throughout the structure 11 to have a continuous combined field of view (FOV) 15 which is made up of the respective FOVs 15₁₋ₙ of each of the 3D depth sensors 14₁₋ₙ. For purposes of clarity and brevity, the following description will relate to the case in which the network of 3D depth sensors 14₁₋ₙ are deployed throughout the structure 11 to have the continuous combined field of view (FOV) 15.

With reference to FIG. 5, an object tracking method is provided.

As shown in FIG. 5, the object tracking method initially includes deploying 3D depth sensors to have at least a nearly continuous combined FOV or a continuous combined FOV (block 501). In accordance with embodiments, the deploying of the 3D depth sensors may include deploying the 3D depth sensors in a network within a structure formed to define an object tracking region such that the nearly continuous or continuous combined FOV overlaps with at least a portion of the object tracking region.

In any case, the object tracking method further includes spatially and temporally synchronizing the 3D depth sensors to world coordinates (or a coordinate system) and a reference time, respectively (blocks 502 and 503). As explained above, the spatial synchronization of block 502 may be obtained from a comparison between 3D depth sensor output and a coordinate system defined for the object tracking region and each of the 3D depth sensors. The temporal synchronization of block 503, as explained above, may be obtained by one of reference to a network time and from time stamps of the output of the 3D depth sensors.

Thus, in accordance with embodiments, the spatially synchronizing of the 3D depth sensors to the world coordinates of block 502 may include calibrating each of the 3D depth sensors to the world coordinates (block 5021). Similarly, the temporally synchronizing of the 3D depth sensors to the reference time of block 503 may include one of linking to a network time (block 5031) and time stamping output of each of the 3D depth sensors (block 5032).

The method may then include collecting three-coordinate depth points from each 3D depth sensor (block 504), converting at least two of the three-coordinate depth points to depth points of the world coordinates (block 505) and projecting the depth points of the world coordinates onto a 2D plane (block 506). The collection of three-coordinate depth points of block 504 can be conducted with respect to the output of the 3D depth sensors and a number of the collected three-coordinate depth points can be established ahead of time or during the collection process itself in accordance with an analysis of the spread of the three-coordinate depth points (i.e., a small spread might require fewer points whereas a larger spread might require a larger number of points).

The conversion and projection of blocks 505 and 506 can be executed in any order.

The method may also include executing data association (block 507). The executing of the data association of block 507 is conducted with respect to the projection of the depth points of the world coordinates onto sequential maps or frames of the 2D plane during passage of the reference time. The execution of data association thus serves to remove or facilitate removal of outlier tracklets formed by projected depth points in a relatively small and updateable number of the maps or frames and to group remaining tracklets formed by projected depth points in a relatively large and updateable number of the maps or frames. In accordance with embodiments, the relatively small and large numbers of the maps or frames are updateable in accordance with a desired accuracy of the object tracking method, available computation time and resources and historical records.

The object tracking method may further include executing a nearest neighbor search to group the remaining tracklets (block 508). This can be done by, for example, an automatic process of image recognition on a computing device.

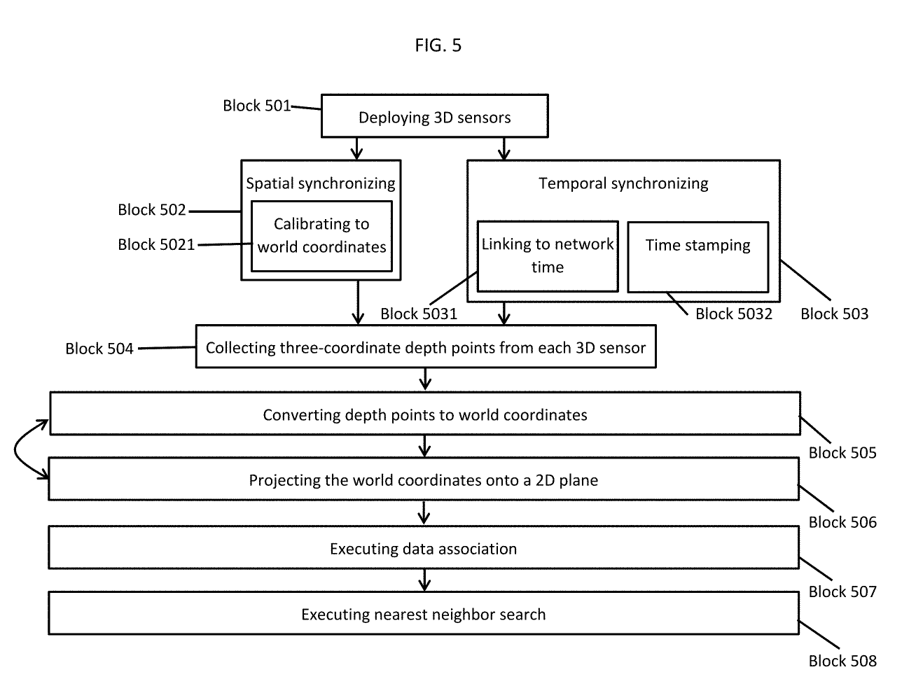

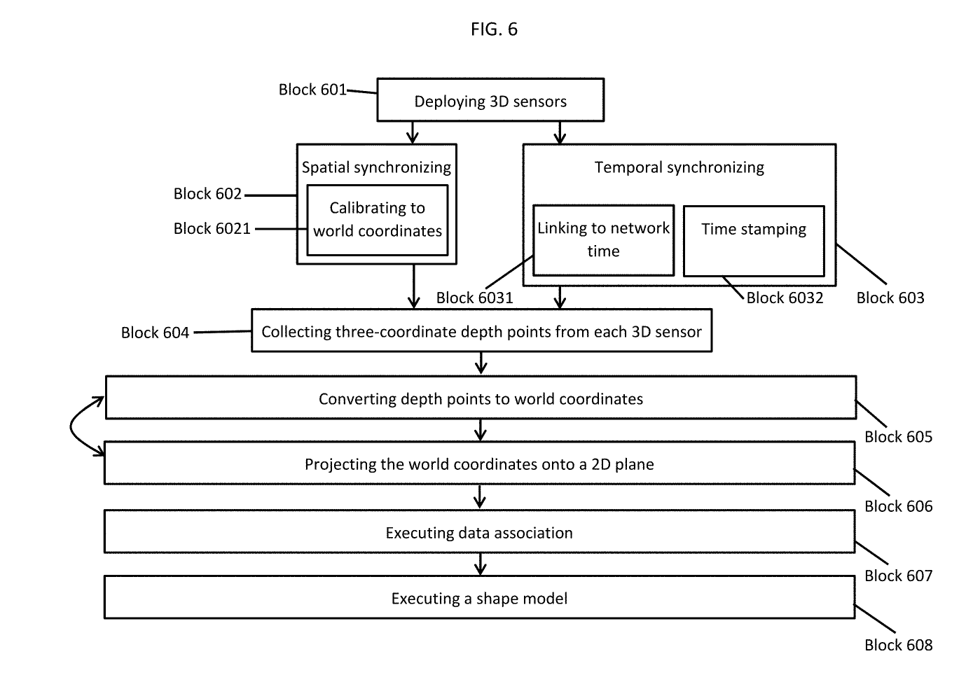

With reference to FIG. 6, an object tracking method is provided.

As shown in FIG. 6, the object tracking method includes deploying 3D depth sensors to have at least a nearly continuous combined FOV or a continuous combined FOV (block 601). In accordance with embodiments, the deploying of the 3D depth sensors may include deploying the 3D depth sensors in a network within a structure formed to define an object tracking region such that the nearly continuous or continuous combined FOV overlaps with at least a portion of the object tracking region.

In any case, the object tracking method further includes spatially and temporally synchronizing the 3D depth sensors to world coordinates (or a coordinate system) and a reference time, respectively (blocks 602 and 603). As explained above, the spatial synchronization of block 602 may be obtained from a comparison between 3D depth sensor output and a coordinate system defined for the object tracking region and each of the 3D depth sensors. The temporal synchronization of block 603, as explained above, may be obtained by one of reference to a network time and from time stamps of the output of the 3D depth sensors.

Thus, in accordance with embodiments, the spatially synchronizing of the 3D depth sensors to the world coordinates of block 602 may include calibrating each of the 3D depth sensors to the world coordinates (block 6021). Similarly, the temporally synchronizing of the 3D depth sensors to the reference time of block 603 may include one of linking to a network time (block 6031) and time stamping output of each of the 3D depth sensors (block 6032).

The method may then include collecting three-coordinate depth points from each 3D depth sensor (block 604), converting each of the three-coordinate depth points to depth points of the world coordinates (block 605) and projecting the depth points of the world coordinates onto a 2D plane (block 606). The collection of three-coordinate depth points of block 604 can be conducted with respect to the output of the 3D depth sensors and a number of the collected three-coordinate depth points can be established ahead of time or during the collection process itself in accordance with an analysis of the spread of the three-coordinate depth points (i.e., a small spread might require fewer points whereas a larger spread might require a larger number of points).

The conversion and projection of blocks 605 and 606 can be executed in any order.

The method may also include executing data association (block 607). The executing of the data association of block 607 is conducted with respect to the projection of the depth points of the world coordinates onto sequential maps or frames of the 2D plane during passage of the reference time. The execution of data association thus serves to remove or facilitate removal of outlier tracklets formed by projected depth points in a relatively small and updateable number of the maps or frames and to group remaining tracklets formed by projected depth points in a relatively large and updateable number of the maps or frames. In accordance with embodiments, the relatively small and large numbers of the maps or frames are updateable in accordance with a desired accuracy of the object tracking method, available computation time and resources and historical records.

The object tracking method may further include executing a shape model to aggregate multiple points with a specific spatial distribution (the model) for subsequent projection to the world coordinate plane and tracking or to aggregate multiple projected points into one point for subsequent tracking (block 608). This can be done by, for example, an automatic process of image recognition on a computing device.

In accordance with embodiments, an aggregation of points into one point representing one object by use of a shape model, as in block 608, may be achieved by clustering points and fitting the points of each cluster to the shape model by minimizing the sum of absolute distances of points to the shape model. The clustering may be by K-means, Expectation-maximization (EM), Fuzzy C-means, Hierarchical clustering, Mixture of Gaussians and the like. The associated distance metric may be the Minkowski metric with p=1, 2, or ∞ and the like. The shape model may be a low-order human kinematic model (skeleton), an x-y centroid model (vertical line) and the like. Some models may include additional parameters in the optimization, e.g., for pose and scale.

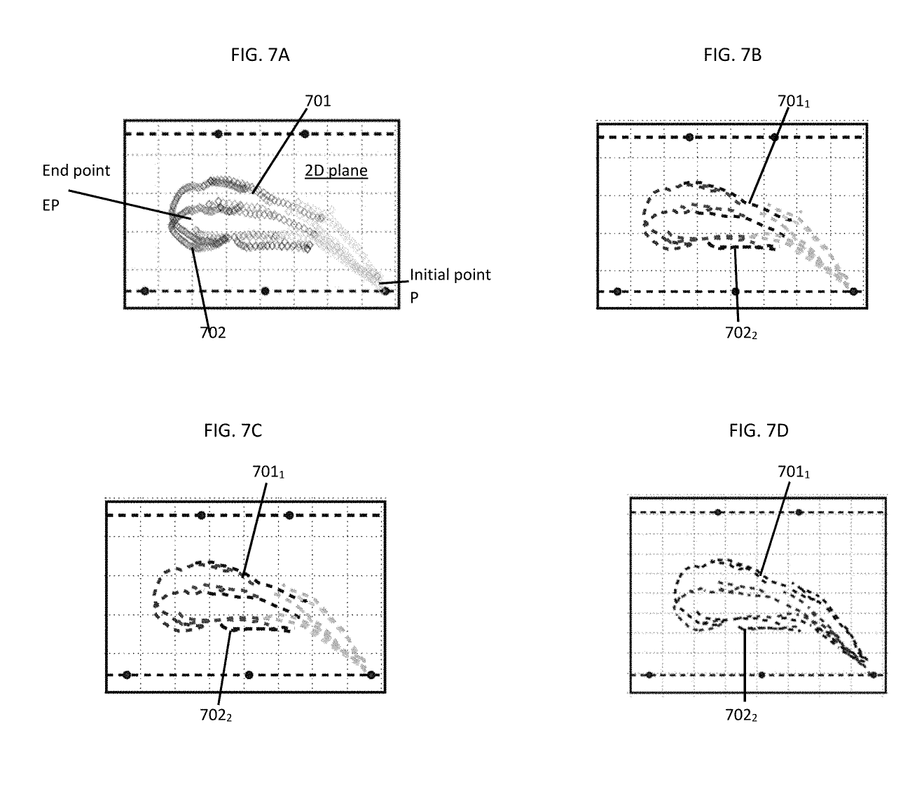

With reference to FIGS. 7A-7D, a graphical depiction of the method of FIG. 5 is provided.

As shown in FIG. 7A, depth points of two different but similarly shaped and sized objects 701 and 702, which are taken from multiple 3D depth sensors as the objects 701 and 702 move in different tracks through a defined space from an initial point P, around an end point EP and back to the initial point P, are projected onto a 2D plane as described above.

As shown in FIG. 7B, the objects 701 and 702 are tracked by each 3D depth sensor individually. The individual 3D depth sensor tracking may be performed by linear or non-linear Bayesian Estimation techniques, which include both Kalman Filters and particle Filters, depending on mathematical assumptions. This tracking may result in a large number of first tracklets 701₁ for object 701 and a large number of second tracklets 702₂ for object 702.

Of the first tracklets 701₁, the outlier first tracklets 701₁, which are defined as those first tracklets 701₁ that are generated by points that occur in only a small number of maps or frames, are removed as shown in FIG. 7C (relative to FIG. 7B). Similarly, of the second tracklets 701₂, the outlier second tracklets 701₂, which are defined as those second tracklets 701₂ that are generated by points that occur in only a small number of maps or frames, are also removed as shown in FIG. 7C (relative to FIG. 7B).

Finally, as shown in FIG. 7D, data association is executed to group the remaining first tracklets 701₁ together by a nearest neighbor search and to group the remaining second tracklets 702₂ together by a nearest neighbor search. For the nearest neighbor search, the distance between two tracklets may be defined as the Frechet distance. The resulting trajectories of FIG. 7D thus indicate that the two objects 701 and 702 (i.e., pedestrians) were moving in the depth sensor network as described above (i.e., the continuous combined FOV 15 of FIG. 2) when the data was recorded.

In the case of a nearly continuous FOV, there may be gaps between tracklets of one object corresponding to when it was not within any depth sensor FOV. The tracklet association across gaps may be accomplished by network flow optimization using metric learning and coherent dynamics based on position and additional parameters such as velocity and acceleration.

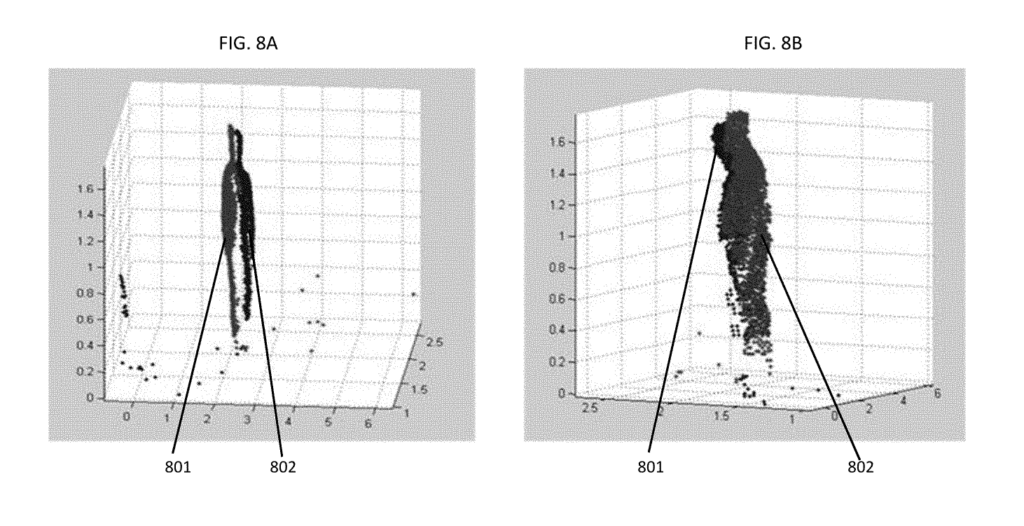

For FIG. 8A, depth sensor data for object 801 from one depth sensor and depth sensor data for object 802 from another depth sensor are associated with each other as a result of the use of a shape model. In this case, a full 3D shape model of a person can be employed to aggregate the depth sensor data as described elsewhere herein. The resulting aggregated data point for the one depth sensor may be projected to the 2D plane as part of a tracklet for the one depth sensor. For FIG. 8B, depth sensor data for object 801 from one depth sensor and depth sensor data for object 802 from another depth sensor are associated with each other as a result of the use of a shape model. In this case, a full 3D shape model of a person was also employed to aggregate the depth sensor data. The resulting aggregated data point for the other depth sensor may be projected to the 2D plane as part of a tracklet for the other depth sensor. The tracklets may be associated as described elsewhere herein. In an alternative embodiment, the depth sensor data may be first projected to the 2D plane and a 2D shape model may be employed to aggregate the projected depth sensor data into an aggregated data point that is part of a tracklet.

Benefits of the features described herein are accurate, wide-area tracking of pedestrians using multiple, simultaneous object tracking across multiple depth sensors employing spatial and temporal consistency and use of multi-perspective shape models for improved tracking accuracy.

While the disclosure is provided in detail in connection with only a limited number of embodiments, it should be readily understood that the disclosure is not limited to such disclosed embodiments. Rather, the disclosure can be modified to incorporate any number of variations, alterations, substitutions or equivalent arrangements not heretofore described, but which are commensurate with the spirit and scope of the disclosure. Additionally, while various embodiments of the disclosure have been described, it is to be understood that the exemplary embodiment(s) may include only some of the described exemplary aspects. Accordingly, the disclosure is not to be seen as limited by the foregoing description, but is only limited by the scope of the appended claims.

What is claimed is:

1. An object tracking system, comprising:
a depth sensor deployed to have at least a nearly continuous field of view (FOV); and
a controller coupled to the depth sensor and configured to:
spatially and temporally synchronize output from the depth sensor, and
track respective movements of individual object within the nearly continuous FOV as each individual object moves through the nearly continuous FOV.

2. The object tracking system according to claim 1, wherein the depth sensor is deployed to have a continuous FOV.

3. The object tracking system according to claim 1, wherein the spatial synchronization is obtained from a comparison between output from the depth sensor and a coordinate system defined for the object tracking region and the depth sensor.

4. The object tracking system according to claim 1, wherein the temporal synchronization is obtained by one or more of reference to a network time and time stamps of the output of the depth sensor.

5. An object tracking system, comprising:
a structure formed to define an object tracking region;
a network of depth sensors deployed throughout the structure to have at least a nearly continuous field of view (FOV) which is overlapped with at least a portion of the object tracking region; and
a controller coupled to the depth sensors, the controller being configured to:
spatially and temporally synchronize output from each of the depth sensors, and
track respective movements of each individual object within the nearly continuous FOV as each individual object moves through the nearly continuous FOV.

6. The object tracking system according to claim 5, wherein the object tracking region comprises an elevator lobby.

7. The object tracking system according to claim 5, wherein the object tracking region comprises a pedestrian walkway in a residential, industrial, military, commercial or municipal property.

8. The object tracking system according to claim 5, wherein the network of depth sensors is deployed throughout the structure to have a continuous FOV.

9. The object tracking system according to claim 5, wherein the spatial synchronization is obtained from a comparison between output from each of the depth sensors and a coordinate system defined for the object tracking region and each of the depth sensors.

10. The object tracking system according to claim 5, wherein the temporal synchronization is obtained by reference to a network time.

11. The object tracking system according to claim 5, wherein the temporal synchronization is obtained from time stamps of the output of each of the depth sensors.

12. An object tracking method, comprising:
deploying depth sensors to have at least a nearly continuous field of view (FOV);
spatially and temporally synchronizing the depth sensors to world coordinates and a reference time;
collecting depth points from each depth sensor;
converting the depth points to depth points of the world coordinates;
projecting the depth points of the world coordinates onto a plane; and
executing data association with respect to the projection of the depth points of the world coordinates onto sequential maps of the plane during passage of the reference time to remove outlier tracklets formed by projected depth points in a relatively small number of the maps and to group remaining tracklets formed by projected depth points in a relatively large number of the maps.

13. The object tracking method according to claim 12, wherein the deploying comprises deploying the depth sensors in a network within a structure formed to define an object tracking region such that the nearly continuous FOV overlaps with at least a portion of the object tracking region.

14. The object tracking method according to claim 12, wherein the deploying comprises deploying the depth sensors to have a continuous FOV.

15. The object tracking method according to claim 12, wherein the spatially synchronizing of the depth sensors to the world coordinates comprises calibrating each of the depth sensors to the world coordinates.

16. The object tracking method according to claim 12, wherein the temporally synchronizing of the depth sensors to the reference time comprises one or more of linking to a network time and time stamping output of each of the depth sensors.

17. The object tracking method according to claim 12, wherein the relatively small and large numbers of the maps are updateable.

18. The object tracking method according to claim 12, further comprising executing a nearest neighbor search to group the remaining tracklets.

19. The object tracking method according to claim 12, wherein the converting of the depth points to the depth points of the world coordinates comprises converting each of the depth points to the depth points of the world coordinates.

20. The object tracking method according to claim 19, further comprising executing a shape model to aggregate multiple points with a spatial distribution for subsequent projection or to aggregate multiple projected points into a point for subsequent tracking.
